(19) United States
(12) Patent Application Publication
(10) Pub. No.: US 2026/0239169 A1
(43) Pub. Date: Aug. 13, 2026

(54) TERMINAL DEVICE, NETWORK DEVICE AND METHODS FOR COMMUNICATIONS

(71) Applicant: LENOVO (BEIJING) LIMITED, Beijing (CN)

(72) Inventors: Ran Yue, Beijing (CN); Luning Liu, Beijing (CN); Jianfeng Wang, Beijing (CN); Lianhai Wu, Beijing (CN)

(21) Appl. No.: 19/475,133

(22) PCT Filed: Apr. 12, 2023
(86) PCT No.: PCT/CN2023/087845

§ 371 Date: Oct. 14, 2025

(51) Int. Cl. H04W 48/02; H04W 48/08

(52) U.S. Cl. CPC H04W 48/02; H04W 48/08

(57) ABSTRACT

Embodiments of the present disclosure relate to a solution for communications. In one aspect of the solution, a terminal device receives indication information from a network device. In turn, terminal device determines a status of access control of the terminal device based on the indication information. The access control is associated with a wireless sensing function supported by the terminal device.

### FIELD

Embodiments of the present disclosure generally relate to the field of communication, and in particular to terminal device, network device and methods for communications.

### BACKGROUND

Integrated Sensing And Communication is considered as a promising topic for future wireless network extension. Integrated Sensing And Communication attempts to merge sensing and communication into a single system, and also pursues a deeper integration paradigm where the two functionalities are no longer viewed as separate end-goals but are co-designed for mutual benefits, i.e., via communication-assisted sensing and sensing-assisted communication. It needs to discuss how to control access of a terminal device to a network device supporting Integrated Sensing And Communication.

### SUMMARY

In general, embodiments of the present disclosure provide a solution for communications.

In a first aspect, there is provided a terminal device. The terminal device comprises a processor and a transceiver coupled to the processor. The processor is configured to: receive indication information via the transceiver from a network device; and determine a status of access control of the terminal device based on the indication information, the access control being associated with a wireless sensing function supported by the terminal device.

In a second aspect, there is provided a network device. The network device comprises a processor and a transceiver coupled to the processor. The processor is configured to: determine indication information for determination of a status of access control of a terminal device, the access control being associated with a wireless sensing function supported by the terminal device and the network device; and transmit the indication information via the transceiver to the terminal device.

In a third aspect, there is provided a method performed by a terminal device. The method comprises: receiving indication information at a terminal device from a network device; and determining a status of access control of the terminal device based on the indication information, the access control being associated with a wireless sensing function supported by the terminal device.

In a fourth aspect, there is provided a method performed by a network device. The method comprises: determining, at a network device, indication information for determination of a status of access control of a terminal device, the access control being associated with a wireless sensing function supported by the terminal device and the network device; and transmitting the indication information to the terminal device.

In a fifth aspect, there is provided a computer readable medium. The computer readable medium has instructions stored thereon. The instructions, when executed on at least one processor of a device, causing the device to perform the method of the third aspect or the fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings in which:

FIG. 1 illustrates a schematic diagram of a communication network in which some embodiments of the present disclosure can be implemented;

FIG. 2 illustrates a signaling chart illustrating an example process for communications in accordance with some embodiments of the present disclosure;

FIG. 3 illustrates a flowchart of a method implemented at a terminal device in accordance with some embodiments of the present disclosure;

FIG. 4 illustrates a flowchart of a method implemented at a network device in accordance with other embodiments of the present disclosure; and

FIG. 5 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms. In some examples, values, procedures, or apparatuses are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

The terminology used herein is for the purpose of describing particular embodiments only and is not intended to be limiting of embodiments. As used herein, the singular forms “a,” “an” and “the” are intended to include the plural forms as well, unless the context clearly indicates otherwise. It will be further understood that the terms “comprises,” “comprising,” “has,” “having,” “includes” and/or “including,” when used herein, specify the presence of stated features, elements, components and/or the like, but do not preclude the presence or addition of one or more other features, elements, components and/or combinations thereof. For example, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The use of an expression such as “A and/or B” can mean either “only A” or “only B” or “both A and B.” Other definitions, explicit and implicit, may be included below.

As used herein, the term “communication network” refers to a network following any suitable communication standards, such as, New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VOIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

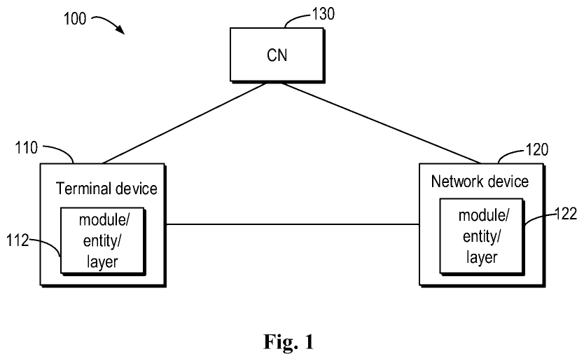

FIG. 1 illustrates a schematic diagram of an example communication network 100 in which embodiments of the present disclosure can be implemented. As shown in FIG. 1, the communication network 100 may include a terminal device 110, a network device 120 and a core network (CN) 130.

In some embodiments, communications in the communication network 100 may comprise Integrated Sensing And Communication. In other words, the communication network 100 may support a wireless sensing function. Hereinafter, the terms “wireless sensing function” is also referred to as “wireless sensing”, “wireless sensing technology”, “sensing and communication”, “radio sensing” or Integrated Sensing And Communication.

The communication network 100 supporting wireless sensing may structure sharing hardware architectures, channel characteristics and signal processing, and integrate types of sensing information, such as sensory data from the environment and radar based sensing information, and communication information to achieve higher resource efficiency and provide more intelligent and integrated network solutions. The communication network 100 supporting wireless sensing can be applied to more extensive scenarios, including smart home, smart manufacturing, environmental monitoring, and so on.

In order to support wireless sensing, the terminal device 110 may be communicatively coupled to at least one module, entity or layer 112 which is associated with a wireless sensing function.

In some embodiments, examples of the wireless sensing function may include but are not limited to: a healthcare function, a smart home function, a blood pressure function, a heart rate function, an air conditioner control function, smart factory function, smart traffic function.

In some embodiments, the at least one module, entity or layer 112 may be integrated into the terminal device 110. Alternatively, the at least one module, entity or layer 112 may be physically separate from the terminal device 110.

In some embodiments, the terminal device 110 supporting wireless sensing may be an updated terminal device with the wireless sensing function. In such embodiments, no new module may be added to realize the wireless sensing function. Just the wireless sensing function is added to a legacy terminal device. In such embodiments, the at least one module, entity or layer 112 may be at least one existing module, entity or layer in a terminal device. For example, the at least one module, entity or layer 112 may be an existing MAC entity or the existing RRC layer.

In some embodiments, the at least one module, entity or layer 112 may be at least one new module, entity, layer.

Alternatively, in some embodiments, the terminal device 110 may be a new specific-functional device special for sensing and communication. The scope of the present disclosure is not limited in this regard.

Similarly, in order to support a wireless sensing function, the network device 120 may be communicatively coupled to at least one module, entity or layer 122. For example, the network device 120 may be implemented as a gNB in NR supporting the wireless sensing function.

In some embodiments, the CN 130 may be implemented as a sensing related CN or an updated CN supporting the wireless sensing function.

In some embodiments, the CN 130 may comprise a node or device supporting the wireless sensing function. For example, the CN 130 may comprise an updated Access and Mobility management Function (AMF) supporting the wireless sensing function.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), the sixth generation (6G) communication protocols.

It is to be understood that the number of devices in FIG. 1 is given for the purpose of illustration without suggesting any limitations to the present disclosure. The communication network 100 may include any suitable number of devices adapted for implementing embodiments of the present disclosure.

In NR, for access requests triggered by a non-access stratum (NAS) layer of a terminal device, the NAS layer determines an Access Category and Access Identity(ies). Considering the potential architecture with a sensing related CN or the updated CN or AMF supporting the wireless sensing function or device, an access attempt related to the wireless sensing may not be triggered by the NAS layer.

In addition, in legacy, a Next Generation Radio Access Network (NG-RAN) supports overload and access control functionality such as Random Access Channel (RACH) back off, Radio Resource Control (RRC) Connection Reject, RRC Connection Release and UE based access barring mechanisms. In order to make a terminal device access to the network supporting wireless sensing, an access control procedure shall be considered.

In legacy, an Access Category of 3 is used to indicate an access attempt is for Mobile Original (MO) signalling and an Access Category of 7 is used to indicate an access attempt is for MO data. If the Access Category of 3 or the Access Category of 7 is reused, it cannot distinguish a sensing and communication message from the legacy MO signaling or MO data. When the wireless sensing technology is applied in some special cases such as healthcare, the data signalling for the wireless sensing function could be more important and urgent. Thus, it is better to distinguish this kind of data or signalling from the legacy MO signaling or MO data.

In view of the above, embodiments of the present disclosure provide a solution for communications. In this solution, a terminal device receives indication information from a network device. In turn, terminal device determines a status of access control of the terminal device based on the indication information. The access control is associated with a wireless sensing function supported by the terminal device. In this way, control access of a terminal device supporting a wireless sensing function may be achieved.

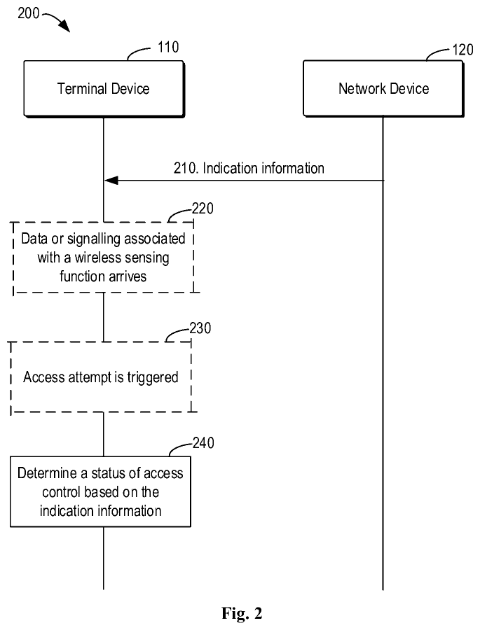

Hereinafter, principle of the present disclosure will be described with reference to FIGS. 2 to 5.

FIG. 2 illustrates a signaling chart illustrating an example process 200 for communications in accordance with some embodiments of the present disclosure. For the purpose of discussion, the process 200 will be described with reference to FIG. 1. The process 200 may involve the terminal device 110 and the second network device 120.

As shown in FIG. 2, the second network device 120 transmits 210 indication information to the terminal device 110. Accordingly, the terminal device 110 receives the indication information from the second network device 120.

In some embodiments, the second network device 120 may broadcast system information and the system information may comprise the indication information.

In some embodiments, data or signalling associated with a wireless sensing function arrives 220.

In turn, an access attempt is triggered 230.

In some embodiments, the access attempt may be triggered by the at least one module, entity or layer 112. In such embodiments, the at least one module, entity or layer 112 may determine information related to the access control. The information related to the access control may be associated with a first access control parameter set for the wireless sensing function. Then, the at least one module, entity or layer 112 may provide the information related to the access control to an access stratum (AS) layer of the terminal device 110.

Alternatively, in some embodiments, the access attempt may be initiated by the at least one module, entity or layer 112. In such embodiments, the at least one module, entity or layer 112 may determine the information related to the access control. In turn, the at least one module, entity or layer 112 may provide the information related to the access control to a NAS layer of the terminal device 110. In turn, the NAS layer of the terminal device 110 may trigger the access attempt and provide the information related to the access control to the AS layer of the terminal device 110.

With continued reference to FIG. 2, the terminal device 110 determines 240 a status of access control of the terminal device 110 based on the indication information. The access control is associated with the wireless sensing function supported by the terminal device 110.

In some embodiments, the status of access control may comprise: the access attempt is allowed or the access attempt is not allowed. In other words, by determining the status of access control of the terminal device 110, the terminal device 110 may determine that the access attempt is allowed or not allowed.

In some embodiments, the AS layer of the terminal device 110 may determine the status of access control of the terminal device 110 based on the indication information.

In some embodiments, the indication information may comprise a list of access control parameter sets and the list may comprise a first access control parameter set for the wireless sensing function.

In some embodiments, the terminal device 110 may receive the indication information e.g. by receiving a UAC-BarringInfoSetList information element (IE), from the network device 120. A list of access control parameter sets may be included in the indication information e.g. included in the UAC-BarringInfoSetList IE. An access category with access parameters may be received according to one of the access control parameter sets. For example, the UAC-BarringInfoSetList IE may be defined as below:

| | |
|---|---|
| UAC-BarringInfoSetList ::= | SEQUENCE (SIZE(1.. maxBarringInfoSet)) OF |
| UAC-BarringInfoSet | |
| UAC-BarringInfoSet ::= | SEQUENCE { |
| uac-BarringFactor | ENUMERATED {p00, p05, p10, p15, p20, p25, p30, |
| | p40, p50, p60, p70, p75, p80, |
| | p85, p90, p95}, |
| uac-BarringTime | ENUMERATED {s4, s8, s16, s32, s64, s128, s256, |
| | s512}, |
| uac-BarringForAccessIdentity | BIT STRING (SIZE(7)) |
| } | |

where “UAC-BarringInfoSetList” represents the UAC-BarringInfoSetList IE, “UAC-BarringInfoSet” represents an access control parameter set for one access category.

Table 1 gives filed descriptions of the UAC-BarringInfoSetList IE.

TABLE 1
UAC-BarringInfoSetList field descriptions
uac-BarringInfoSetList
List of access control parameter sets. Each access category can be configured with access
parameters corresponding to a particular set by uac-barringInfoSetIndex. Association of an access
category with an index that has no corresponding entry in the uac-BarringInfoSetList is valid
configuration and indicates no barring.
uac-BarringForAccessIdentity
Indicates whether access attempt is allowed for each Access Identity. The leftmost bit, bit 0 in the
bit string corresponds to Access Identity 1, bit 1 in the bit string corresponds to Access Identity 2,
bit 2 in the bit string corresponds to Access Identity 11, bit 3 in the bit string corresponds to
Access Identity 12, bit 4 in the bit string corresponds to Access Identity 13, bit 5 in the bit string
corresponds to Access Identity 14, and bit 6 in the bit string corresponds to Access Identity 15.
Value 0 means that access attempt is allowed for the corresponding access identity.
uac-BarringFactor
Represents the probability that access attempt would be allowed during access barring check.
uac-BarringTime
The minimum time in seconds before a new access attempt is to be performed after an access
attempt was barred at access barring check for the same access category.

In some embodiments, the list of access control parameter sets may comprise a first access control parameter set for the wireless sensing function.

As described above, examples of the wireless sensing function may include but are not limited to: a healthcare function, a smart home function, a blood pressure function, a heart rate function, and an air conditioner control function.

In some embodiments, the list of access control parameter sets may comprise an access control parameter set for each of the above wireless sensing functions. For example, the list of access control parameter sets may comprise an access control parameter set for the healthcare function, an access control parameter set for the smart home function and so on.

As described above with reference to FIG. 2, the at least one module, entity or layer 112 may determine information related to the access control. The at least one module, entity or layer 112 may be at least one new module, entity or layer. Alternatively, the at least one module, entity or layer 112 may be at least one existing module, entity or layer. In some embodiments, the information related to the access control may comprise at least one of the following: an access category for the wireless sensing function, or an access identity for the wireless sensing function.

In some embodiments, the information related to the access control may be associated with the first access control parameter set for the wireless sensing function. Thus, the terminal device 110 may the first access control parameter set for the wireless sensing function based on the information related to the access control. For example, the terminal device 110 may determine the first access control parameter set for the wireless sensing function based on the access category for the wireless sensing function. In other words, the terminal device 110 may select the first access control parameter set from the list of access control parameter sets based on the access category for the wireless sensing function.

In some embodiments, the terminal device 110 may receive, from the network device 120, association information between the access category and the first access control parameter set for the wireless sensing function.

In some embodiments, the terminal device 110 may receive the association information by receiving a UAC-BarringPerCat IE from the network device 120. For example, the UAC-BarringPerCat IE may be defined as below:

| | |
|---|---|
| UAC-BarringPerCat ::= | SEQUENCE { |
| accessCategory | INTEGER (1..maxAccessCat-1), |
| uac-barringInfoSetIndex | UAC-BarringInfoSetIndex |
| } | |

where “UAC-BarringPerCat” represents access control parameters for an access category indicated by the field “accessCategory”, “accessCategory” represents an access category, “uac-barringInfoSetIndex” represents an index to an access control parameter set in uac-BarringInfoSetList IE.

In some embodiments, the access category may comprise a dedicated access category for the wireless sensing function. Additionally, or alternatively, the access identity may comprise a dedicated access identity for the wireless sensing function, which will be described later with reference to Table 3.

In such embodiments, Table 2 gives an example of mapping table for access categories:

TABLE 2

| | | | Access |
|---|---|---|---|
| Rule # | Type of access attempt | Requirements to be met | Category |
| 1 | Response to paging or | Access attempt is for MT access | 0 (= MT_acc) |
| | NOTIFICATION over | | |
| | non-3GPP access; | | |
| | 5GMM connection | | |
| | management procedure | | |
| | initiated for the purpose | | |
| | of transporting an LPP | | |
| | message | | |
| 2 | Emergency | UE is attempting access for an | 2 (= emergency) |
| | | emergency session (NOTE 1, | |
| | | NOTE 2) | |
| 3 | Access attempt for | UE stores operator-defined access | 32-63 |
| | operator-defined access | category definitions valid in the | (= based on |
| | category | current PLMN as specified in | operator |
| | | subclause 4.5.3, and access attempt | classification |
| | | is matching criteria of an | A |
| | | operator-defined access category | |
| | | definition | |
| 4 | Access attempt for delay | (a) UE is configured for NAS | 1 (= delay |
| | tolerant service | signalling low priority or UE | tolerant) |
| | | supporting S1 mode is configured for | |
| | | EAB (see the | |
| | | “ExtendedAccessBarring” leaf of | |
| | | NAS configuration MO in | |
| | | 3GPP TS 24.368 [17] or | |
| | | 3GPP TS 31.102 [22]) where “EAB | |
| | | override” does not apply, and | |
| | | (b). the UE received one of the | |
| | | categories a, b or c as part of the | |
| | | parameters for unified access control | |
| | | in the broadcast system information, | |
| | | and the UE is a member of the | |
| | | broadcasted category in the selected | |
| | | PLMN or RPLMN/equivalent | |
| | | PLMN | |
| | | (NOTE 3, NOTE 5, NOTE 6, | |
| | | NOTE 7, NOTE 8) | |
| 5 | MO MMTel voice call | Access attempt is for MO MMTel | 4 (= MO |
| | | voice call | MMTel |
| | | or for NAS signalling connection | voice) |
| | | recovery during ongoing MO | |
| | | MMTel voice call | |
| | | (NOTE 2) | |
| 6 | MO MMTel video call | Access attempt is for MO MMTel | 5 (= MO |
| | | video call or | MMTel |
| | | for NAS signalling connection | video) |
| | | recovery during ongoing MO | |
| | | MMTel video call | |
| | | (NOTE 2) | |
| 7 | MO SMS over NAS or | Access attempt is for MO | 6 (= MO |
| | | SMS over | SMS and |
| | | NAS (NOTE 4) or MO SMS over | SMSoIP) |
| | MO SMSoIP | SMSoIP transfer | |
| | | or for NAS signalling connection | |
| | | recovery during ongoing | |
| | | MO SMS | |
| | | or SMSoIP transfer (NOTE 2) | |
| 8 | UE NAS initiated | Access attempt is for MO | 3 (= MO_sig) |
| | 5GMM specific | signalling | |
| | procedures | | |
| 9 | UE NAS initiated | Access attempt is for MO data | 7 (= MO_data) |
| | 5GMM connection | | |
| | management procedure | | |
| | or 5GMM NAS | | |
| | transport procedure | | |
| 10 | An uplink user data | No further requirement | 7 (= MO_data) |
| | packet is to be sent for a | is to be met | |
| | PDU session with | | |
| | suspended user-plane | | |
| | resources | | |
| 11 | Data or signalling | Access attempt is for MO data or | 8 (= |
| | associated with a | signalling associated with a | MO data-se |
| | wireless sensing | wireless sensing function | nsing or |
| | function | | MO_signalli |
| | | | ng-sensing) |

As shown in Table 2, a dedicated access category (i.e., 8) is defined for the wireless sensing function. In such embodiments, the field “accessCategory” in the “UAC-BarringPerCat” IE may be set to be “8” so as to the “UAC-BarringPerCat” IE is associated with the wireless sensing function. Accordingly, “uac-barringInfoSetIndex” represents an index to the first access control parameter set in uac-BarringInfoSetList IE which is associated with the wireless sensing function.

It shall be noted that the dedicated access category has been described by taking “8” as an example. In other embodiments, the dedicated access category may be defined as any appropriate value. The scope of the present disclosure is not limited in this regard.

In embodiments where the terminal device 110 supports more than one wireless sensing functions, a dedicated access category may be defined for each of the wireless sensing functions. For example, one dedicated access category (such as 8) may be defined for the healthcare function, and another dedicated access category (such as 9) may be defined for the smart home function and so on.

Alternatively, a dedicated access category may be defined for all of the wireless sensing functions.

In some embodiments, a legacy access category may be defined for a wireless sensing function or for all of the wireless sensing functions. In such embodiments, the UAC-BarringPerCat IE may be updated by adding a new index to the first access control parameter set in uac-BarringInfoSetList IE which is associated with the wireless sensing function. For example, the updated UAC-BarringPerCat IE may be defined as below:

| | |
|---|---|
| UAC-BarringPerCat ::= | SEQUENCE { |
| accessCategory | INTEGER (1 .. maxAccessCat-1), |
| uac-barringInfoSetIndex | UAC-BarringInfoSetIndex |
| uac-barringInfoSetIndex- | UAC-BarringInfoSetIndex |
| sensing-F1 | |
| } | |

where “uac-barringInfoSetIndex-sensing-F1” represents an index to the first access control parameter set in uac-BarringInfoSetList IE. The first access control parameter set is associated with the wireless sensing function.

Alternatively, in some embodiments, a legacy UAC-BarringPerCat IE may be used. In other words, the UAC-BarringPerCat IE does not comprise the field “uac-barringInfoSetIndex-sensing-F1”. In such embodiments, the first access control parameter set comprises at least one dedicated access control parameter for the wireless sensing function. For example, the UAC-BarringInfoSet IE described above may be updated by adding the at least one dedicated access control parameter for the wireless sensing function. For example, the updated UAC-BarringInfoSet IE may be defined as below:

| | |
|---|---|
| UAC-BarringInfoSet ::= | SEQUENCE { |
| uac-BarringFactor | ENUMERATED {p00, p05, p10, p15, p20, p25, p30, |
| | p40, p50, p60, p70, p75, p80, p85, |
| | p90, p95}, |
| uac-BarringTime | ENUMERATED {s4, s8, s16, s32, s64, s128, s256, |
| | s512}, |
| uac-BarringForAccessIdentity | BIT STRING (SIZE(7)) |
| uac-BarringFactor-sensing-F1 | ENUMERATED {p00, p05, p10, p15, p20, p25, |
| | p30, p40, p50, p60, p70, p75, |
| | p80, p85, p90, p95}, |
| uac-BarringTime-sensing-F1 | ENUMERATED {s4, s8, s16, s32, s64, s128, s256, |
| | s512}, |
| uac-BarringForAccessIdentity-sensing-F1 | BIT STRING (SIZE(7)) |
| } | |

Table 3 gives s descriptions of the newly added fields of the UAC-BarringInfoSetList IE.

TABLE 3
Descriptions of the newly added fileds of the UAC-BarringInfoSetList IE
uac-BarringForAccessIdentity-sensing-F1
For example, at least one byte or at least one bit may be added to
uac-BarringForAccessIdentity so as to indicate whether access attempt for data or
signalling associated with a wireless sensing function (represented by F1) is allowed for
an Access Identity associated with the wireless sensing function (represented by F1).
For example, bit 7 in the bit string corresponds to Access Identity 16 associated with
the wireless sensing function (represented by F1). Value 0 means that access attempt for
data or signalling associated with a wireless sensing function (represented by F1) is
allowed for the corresponding access identity.
uac-BarringFactor-sensing-F1
Represents the probability that access attempt for data or signalling associated with a
wireless sensing function (represented by F1) would be allowed during access
barring check.
uac-BarringTime-sensing-F1
The minimum time in seconds before a new access attempt for data or signalling
associated with a wireless sensing function (represented by F1) is to be performed after
an access attempt for data or signalling associated with a wireless sensing function
(represented by F1) was barred at access barring check for the same access category.

In some embodiments, the indication information received from the network device 120 may comprise at least one of the following: a cell bar indication, or a dedicated cell bar indication for the wireless sensing function. Hereinafter, the cell bar indication is also referred to as a legacy cell bar indication.

In such embodiments, the terminal device 110 may receive the indication information by receiving system information, such as Master Information Block (MIB) or System Information Block (SIB e.g. SIB1 and/or SIB2 and/or other SIBs and/or new added SIB(s)).

In some embodiments, a legacy terminal device which does not support the wireless sensing function may determine a status of access control of the legacy terminal device based on the legacy cell bar indication. The terminal device 110 supporting the wireless sensing function may ignore the legacy cell bar indication. In other words, the terminal device 110 may determine the status of access control only based on the dedicated cell bar indication.

For example, the legacy cell bar indication may be set to “barred” to indicate a first cell is barred while the dedicated cell bar indication may be set to “not barred” to indicate the first cell is not barred. The legacy terminal device may determine that the legacy terminal device is not permitted to select or reselect or access the first cell. The terminal device 110 supporting the wireless sensing function may determine that the terminal device 110 is allowed to select or reselect or access the first cell.

In some embodiments, the dedicated cell bar indication may work when the legacy cell bar indication is set to “barred”. For example, if the cell bar indication indicates the first cell is not barred, the terminal device 110 may not detect the dedicated cell bar indication. If the cell bar indication indicates the first cell is barred, the terminal device 110 may detect the dedicated cell bar indication to determine the first status of access control for the first cell based on the dedicated cell bar indication.

Alternatively, in some embodiments, the dedicated cell bar indication may work when the legacy cell bar indication is set to “not barred”. For example, if the cell bar indication indicates the first cell is not barred, the terminal device 110 may detect the dedicated cell bar indication to determine the first status of access control for the first cell based on the dedicated cell bar indication.

In some embodiments, the indication information received from the network device 120 may further comprise at least one of the following: a cell selection indication indicating whether selection or reselection to intra-frequency cells is allowed, or a dedicated cell selection indication for the wireless sensing function which indicates whether the selection or reselection to intra-frequency cells is allowed. Hereinafter, the cell selection indication may be referred to as a legacy cell selection indication and represented by intraFreqReselection. The dedicated cell selection indication may be represented by intraFreqReselection-sensing-F1 where F1 represents the wireless sensing function.

In some embodiments, if the legacy cell bar indication indicates a first cell is barred, the terminal device 110 supporting the wireless sensing function may ignore the intraFreqReselection or consider the intraFreqReselection being set to “allowed”.

For example, if the legacy cell bar indication indicates the first cell is barred and intraFreqReselection is set to “not allowed” to indicate that selection or reselection to the second cell is not allowed, the terminal device 110 may ignore the intraFreqReselection or consider the intraFreqReselection being set to “allowed”.

In some embodiments, if the legacy cell bar indication indicates the first cell is barred, the terminal device 110 supporting the wireless sensing function may determine a second status of access control for a second cell only based on the dedicated cell selection indication. The second cell is on the same frequency as the first cell. In such embodiments, the terminal device 110 may ignore the intraFreqReselection.

In some embodiments, the terminal device 110 may transmit an indication of the wireless sensing function to the network device 120.

In some embodiments, the indication of the wireless sensing function may indicate the terminal device 110 is a new specific-functional terminal device.

In some embodiments, the terminal device 110 may transmit an uplink message associated with a random access procedure. The uplink message may comprise the indication of the wireless sensing function. For example, the uplink message may comprise at least one of the following: Msg 1, Msg3, MsgA Physical Uplink Shared Channel (PUSCH), or MsgA Physical Random Access Channel (PRACH).

In some embodiments, when a Random Access procedure is initiated, the terminal device 110 may select a set of Random Access (RA) resources and initialize one or more parameters for the Random Access procedure according to the values configured by RRC for the selected set of Random Access resources.

For example, the terminal device 110 may initialize “prach-ConfigurationIndex” which indicates the available set of PRACH occasions for the transmission of the Random Access Preamble for Msg1. These are also applicable to the MSGA PRACH if the PRACH occasions are shared between 2-step and 4-step RA types.

In some embodiments, for each MSGA, an MAC entity of the terminal device 110 may instruct a physical layer of the terminal device 110 to transmit the MSGA using the selected PRACH occasion and the associated PUSCH resource of MSGA.

In some embodiments, if the uplink message comprises Msg3 or MsgA on PUSCH, the uplink message may comprise a dedicated Medium Access Control Control Element (MAC CE) which may comprise the indication of the wireless sensing function. For example, one or more wireless sensing functions supported by the terminal device 110 may be indicated in a bitmap in the MAC CE. Alternatively, the one or more wireless sensing functions supported by the terminal device 110 may be explicitly indicated in the MAC CE and/or a corresponding Logical Channel ID (LCID).

In some embodiments, the network device 120 may configure at least one dedicated RACH resource for a wireless sensing function, a specific-functional terminal or for the specific-functional terminals supporting different wireless sensing functions. For example, the at least one dedicated RACH resource may comprise at least one of the following: dedicated preambles, dedicated preamble groups, or dedicated RACH occasions.

In some embodiments, the at least one dedicated RACH resource may be broadcasted by the system information, or configured by a dedicated signalling, or pre-defined, or configured as a default configuration.

In such embodiments, the terminal device 110 may transmit the indication of the wireless sensing function on a dedicated PRACH resource for the wireless sensing function.

In such embodiments, the indication of the wireless sensing function transmitted on the dedicated PRACH resource may indicate the terminal device 110 is a new specific-functional terminal device.

In some embodiments, the indication information received from the network device 120 may comprise a downlink message associated with a random access procedure. The downlink message may comprise an indication whether access attempt of the terminal device 110 is rejected. In turn, the terminal device 110 may determine the status of access control based on the indication.

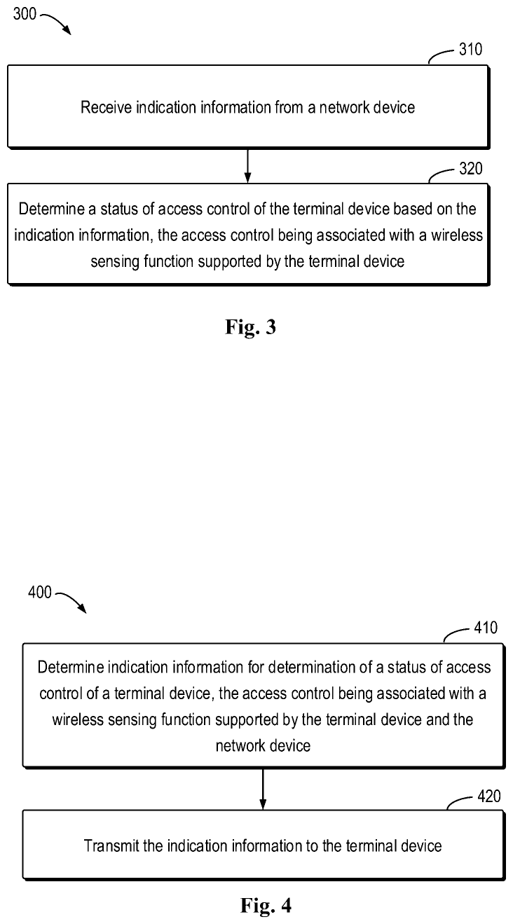

FIG. 3 illustrates a flowchart of a method 300 implemented at a terminal device in accordance with some embodiments of the present disclosure. For the purpose of discussion, the method 300 will be described from the perspective of the terminal device 110 with reference to FIG. 1.

At block 310, the terminal device 110 receives indication information from the network device 120.

At block 320, the terminal device 110 determines a status of access control of the terminal device 110 based on the indication information. The access control is associated with a sensing function supported by the terminal device 110.

In some embodiments, the terminal device 110 is communicatively coupled to at least one module, entity or layer which is associated with the wireless sensing function.

In some embodiments, the indication information may comprise a list of access control parameter sets, and the list may comprise a first access control parameter set for the wireless sensing function.

In some embodiments, the at least one module, entity or layer is further configured to: determine information related to the access control, the information related to the access control being associated with a first access control parameter set for the wireless sensing function; and provide the information related to the access control to one of the following: an access stratum layer of the terminal device 110, or a non-access stratum layer of the terminal device 110.

In some embodiments, the information related to the access control may comprise at least one of the following: an access category for the wireless sensing function, or an access identity for the wireless sensing function.

In some embodiments, the access category may comprise a dedicated access category for the wireless sensing function; and/or the access identity may comprise a dedicated access identity for the wireless sensing function.

In some embodiments, the first access control parameter set comprises at least one dedicated access control parameter for the wireless sensing function.

In some embodiments, the indication information may comprise at least one of the following: a cell bar indication, a dedicated cell bar indication for the wireless sensing function, a cell selection indication indicating whether selection or reselection to intra-frequency cells is allowed, or a dedicated cell selection indication for the wireless sensing function which indicates whether the selection or reselection to intra-frequency cells is allowed.

In some embodiments, determining the status of access control may comprise: determining the status of access control only based on the dedicated cell bar indication.

In some embodiments, determining the status of access control may comprise: based on determining that the cell bar indication indicates a first cell is barred, determining a first status of access control for the first cell based on the dedicated cell bar indication; or based on determining that the cell bar indication indicates the first cell is not barred, determining the first status of access control for the first cell based on the dedicated cell bar indication.

In some embodiments, determining the status of access control may comprise: based on determining that the cell bar indication indicates a first cell is barred, ignoring the cell selection indication or considering the cell selection indication being set to Allowed.

In some embodiments, determining the status of access control may comprise: based on determining that the cell bar indication indicates a first cell is barred, determining a second status of access control for a second cell only based on the dedicated cell selection indication, the second cell being on the same frequency as the first cell.

In some embodiments, the method 300 further comprises: transmitting an indication of the wireless sensing function to the network device 120.

In some embodiments, transmitting the indication of the wireless sensing function may comprise: transmitting an uplink message associated with a random access procedure, the uplink message may comprise the indication.

In some embodiments, the uplink message may comprise a dedicated Medium Access Control Control Element (MAC CE) may comprise the indication.

In some embodiments, transmitting the indication of the wireless sensing function may comprise: transmitting the indication of the wireless sensing function on a Physical Random Access Channel resource for the wireless sensing function.

In some embodiments, receiving the indication information may comprise receiving a downlink message associated with a random access procedure, the downlink message may comprise an indication whether access attempt of the terminal device 110 is rejected; and determining the status of access control may comprise determining the status of access control based on the indication.

FIG. 4 illustrates a flowchart of a method 400 implemented at a network device in accordance with some embodiments of the present disclosure. For the purpose of discussion, the method 400 will be described from the perspective of the network device 120 with reference to FIG. 1.

At block 410, the network device 120 determines indication information for determination of a status of access control of the terminal device 110. The access control is associated with a wireless sensing function supported by the terminal device 110 and the network device 120.

At block 420, the network device 120 transmits the indication information via the transceiver to the terminal device 110.

In some embodiments, the indication information may comprise a list of access control parameter sets, the list may comprise a first access control parameter set for the wireless sensing function.

In some embodiments, the first access control parameter set for the wireless sensing function is associated with information related to the access control. The information related to the access control may comprise at least one of the following: an access category for the wireless sensing function, or an access identity for the wireless sensing function.

In some embodiments, the access category may comprise a dedicated access category for the wireless sensing function; and/or the access identity may comprise a dedicated access identity for the wireless sensing function.

In some embodiments, the first access control parameter set may comprise at least one dedicated access control parameter for the wireless sensing function.

In some embodiments, the indication information may comprise at least one of the following: a cell bar indication, a dedicated cell bar indication for the wireless sensing function, a cell selection indication indicating whether selection or reselection to intra-frequency cells is allowed, or a dedicated cell selection indication for the wireless sensing function which indicates whether the selection or reselection to intra-frequency cells is allowed.

In some embodiments, the method 400 may further comprise: receiving an indication of the wireless sensing function to from the terminal device 110.

In some embodiments, receiving the indication of the wireless sensing function may comprise: receiving an uplink message associated with a random access procedure. The uplink message may comprise the indication.

In some embodiments, the uplink message may comprise a dedicated Medium Access Control Control Element (MAC CE) may comprise the indication.

In some embodiments, receiving the indication of the wireless sensing function may comprise: receiving the indication of the wireless sensing function on a Physical Random Access Channel resource for the wireless sensing function.

In some embodiments, transmitting the indication information may comprise: transmitting a downlink message associated with a random access procedure. The downlink message may comprise an indication whether access attempt of the terminal device 110 is rejected.

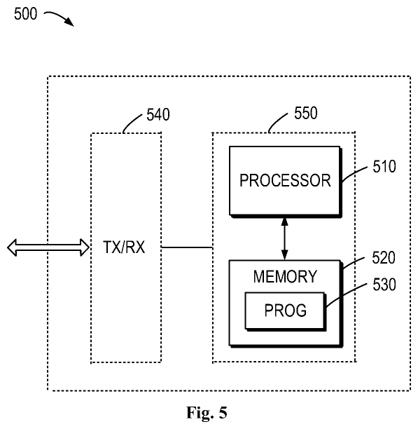

FIG. 5 illustrates a simplified block diagram of an apparatus 500 that is suitable for implementing embodiments of the present disclosure. The apparatus 500 can be considered as a further example implementation of the terminal device 110 or the network device 120 as shown in FIG. 1. Accordingly, the apparatus 500 can be implemented at or as at least a part of the terminal device 110 or the network device 120.

As shown, the apparatus 500 includes a processor 510, a memory 520 coupled to the processor 510, a suitable transmitter (TX) and receiver (RX) 540 coupled to the processor 510, and a communication interface coupled to the TX/RX 540. The memory 510 stores at least a part of a program 530. The TX/RX 540 is for bidirectional communications. The TX/RX 540 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 530 is assumed to include program instructions that, when executed by the associated processor 510, enable the apparatus 500 to operate in accordance with the embodiments of the present disclosure, as discussed herein with reference to FIGS. 1 to 4. The embodiments herein may be implemented by computer software executable by the processor 510 of the apparatus 500, or by hardware, or by a combination of software and hardware. The processor 510 may be configured to implement various embodiments of the present disclosure. Furthermore, a combination of the processor 510 and memory 520 may form processing means 550 adapted to implement various embodiments of the present disclosure.

The memory 520 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 520 is shown in the apparatus 500, there may be several physically distinct memory modules in the apparatus 500. The processor 510 may be of any type suitable to the local technical network, and may include one or more of general purpose computers, special purpose computers, microprocessors, digital signal processors (DSPs) and processors based on multicore processor architecture, as non-limiting examples. The apparatus 500 may have multiple processors, such as an application specific integrated circuit chip that is slaved in time to a clock which synchronizes the main processor.

In summary, embodiments of the present disclosure provide the following solutions.

Clause 1. A terminal device, comprising: a processor; and a transceiver coupled to the processor, wherein the processor is configured to: receive indication information via the transceiver from a network device; and determine a status of access control of the terminal device based on the indication information, the access control being associated with a wireless sensing function supported by the terminal device.

Clause 2. The terminal device of clause 1, wherein the terminal device is communicatively coupled to at least one module, entity or layer which is associated with the wireless sensing function.

Clause 3. The terminal device of clause 1, wherein the indication information comprises a list of access control parameter sets, the list comprising a first access control parameter set for the wireless sensing function.

Clause 4. The terminal device of clause 2, wherein the at least one module, entity or layer is further configured to: determine information related to the access control, the information related to the access control being associated with a first access control parameter set for the wireless sensing function; and provide the information related to the access control to one of the following: an access stratum layer of the terminal device, or a non-access stratum layer of the terminal device.

Clause 5. The terminal device of clause 4, wherein the information related to the access control comprises at least one of the following: an access category for the wireless sensing function, or an access identity for the wireless sensing function.

Clause 6. The terminal device of clause 5, wherein the access category comprises a dedicated access category for the wireless sensing function; and/or the access identity comprises a dedicated access identity for the wireless sensing function.

Clause 7. The terminal device of clause 3, wherein the first access control parameter set comprises at least one dedicated access control parameter for the wireless sensing function.

Clause 8. The terminal device of clause 1, wherein the indication information comprises at least one of the following: a cell bar indication, a dedicated cell bar indication for the wireless sensing function, a cell selection indication indicating whether selection or reselection to intra-frequency cells is allowed, or a dedicated cell selection indication for the wireless sensing function which indicates whether the selection or reselection to intra-frequency cells is allowed.

Clause 9. The terminal device of clause 8, wherein the processor is configured to determine the status of access control by: determining the status of access control only based on the dedicated cell bar indication.

Clause 10. The terminal device of clause 8, wherein the processor is configured to determine the status of access control by: based on determining that the cell bar indication indicates a first cell is barred, determining a first status of access control for the first cell based on the dedicated cell bar indication; or based on determining that the cell bar indication indicates the first cell is not barred, determining the first status of access control for the first cell based on the dedicated cell bar indication.

Clause 11. The terminal device of clause 8, wherein the processor is configured to determine the status of access control by: based on determining that the cell bar indication indicates a first cell is barred, ignoring the cell selection indication or considering the cell selection indication being set to Allowed.

Clause 12. The terminal device of clause 8, wherein the processor is configured to determine the status of access control by: based on determining that the cell bar indication indicates a first cell is barred, determining a second status of access control for a second cell only based on the dedicated cell selection indication, the second cell being on the same frequency as the first cell.

Clause 13. The terminal device of clause 1, wherein the processor is further configured to: transmit an indication of the wireless sensing function via the transceiver to the network device.

Clause 14. The terminal device of clause 13, wherein the processor is configured to transmit the indication of the wireless sensing function by: transmitting an uplink message associated with a random access procedure, the uplink message comprising the indication.

Clause 15. The terminal device of clause 14, wherein the uplink message comprises a dedicated Medium Access Control Control Element (MAC CE) comprising the indication.

Clause 16. The terminal device of clause 13, wherein the processor is configured to transmit the indication of the wireless sensing function by: transmitting the indication of the wireless sensing function on a Physical Random Access Channel resource for the wireless sensing function.

Clause 17. The terminal device of clause 13, wherein the processor is configured to receive the indication information by: receiving a downlink message associated with a random access procedure, the downlink message comprises an indication whether access attempt of the terminal device is rejected; and the processor is configured to determine the status of access control by determining the status of access control based on the indication.

Clause 18. A network device, comprising: a processor; and a transceiver coupled to the processor, wherein the processor is configured to: determine indication information for determination of a status of access control of a terminal device, the access control being associated with a wireless sensing function supported by the terminal device and the network device; and transmit the indication information via the transceiver to the terminal device.

Clause 19. The network device of clause 18, wherein the indication information comprises a list of access control parameter sets, the list comprising a first access control parameter set for the wireless sensing function.

Clause 20. The network device of clause 19, wherein the first access control parameter set for the wireless sensing function is associated with information related to the access control, the information related to the access control comprising at least one of the following: an access category for the wireless sensing function, or an access identity for the wireless sensing function.

Clause 21. The network device of clause 20, wherein the access category comprises a dedicated access category for the wireless sensing function; and/or the access identity comprises a dedicated access identity for the wireless sensing function.

Clause 22. The network device of clause 19, wherein the first access control parameter set comprise at least one dedicated access control parameter for the wireless sensing function.

Clause 23. The network device of clause 18, wherein the indication information comprises at least one of the following: a cell bar indication, a dedicated cell bar indication for the wireless sensing function, a cell selection indication indicating whether selection or reselection to intra-frequency cells is allowed, or a dedicated cell selection indication for the wireless sensing function which indicates whether the selection or reselection to intra-frequency cells is allowed.

Clause 24. The network device of clause 18, wherein the processor is further configured to: receive an indication of the wireless sensing function via the transceiver to from the terminal device.

Clause 25. The network device of clause 24, wherein the processor is configured to receive the indication of the wireless sensing function by: receiving an uplink message associated with a random access procedure, the uplink message comprising the indication.

Clause 26. The network device of clause 25, wherein the uplink message comprises a dedicated Medium Access Control Control Element (MAC CE) comprising the indication.

Clause 27. The network device of clause 24, wherein the processor is configured to receive the indication of the wireless sensing function by: receiving the indication of the wireless sensing function on a Physical Random Access Channel resource for the wireless sensing function.

Clause 28. The network device of clause 24, wherein the processor is configured to transmit the indication information by: transmitting a downlink message associated with a random access procedure, the downlink message comprises an indication whether access attempt of the terminal device is rejected.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device, comprising:
at least one memory; and
at least one processor coupled with the at least one memory
and configured to cause the terminal device to:
receive indication information from a network device; and
determine a status of access control of the terminal device based on the indication information, the access control being associated with a wireless sensing function supported by the terminal device.

2. The terminal device of claim 1, wherein the indication information comprises a list of access control parameter sets, the list comprising a first access control parameter set for the wireless sensing function.

3. The terminal device of claim 1, wherein the terminal device is communicatively coupled to at least one module, entity or layer which is associated with the wireless sensing function.

4. The terminal device of claim 3, wherein the at least one module, entity or layer is further configured to:
determine information related to the access control, the information related to the access control being associated with a first access control parameter set for the wireless sensing function; and
provide the information related to the access control to one of the following:
an access stratum layer of the terminal device, or
a non-access stratum layer of the terminal device.

5. The terminal device of claim 4, wherein the information related to the access control comprises at least one of the following:
an access category for the wireless sensing function, or
an access identity for the wireless sensing function.

6. The terminal device of claim 5, wherein the access category comprises a dedicated access category for the wireless sensing function; and/or
the access identity comprises a dedicated access identity for the wireless sensing function.

7. The terminal device of claim 3, wherein the first access control parameter set comprises at least one dedicated access control parameter for the wireless sensing function.

8. The terminal device of claim 1, wherein the indication information comprises at least one of the following:
a cell bar indication,
a dedicated cell bar indication for the wireless sensing function,
a cell selection indication indicating whether selection or reselection to intra-frequency cells is allowed, or
a dedicated cell selection indication for the wireless sensing function which indicates whether the selection or reselection to intra-frequency cells is allowed.

9. The terminal device of claim 8, wherein the processor is configured to determine the status of access control by:
based on determining that the cell bar indication indicates a first cell is barred, determining a second status of access control for a second cell only based on the dedicated cell selection indication, the second cell being on the same frequency as the first cell.

10. The terminal device of claim 1, wherein the processor is further configured to:
transmit an indication of the wireless sensing function via the transceiver to the network device.

11. A network device, comprising:
at least one memory; and
at least one processor coupled with the at least one memory and configured to cause the network device to:
determine indication information for determination of a status of access control of a terminal device, the access control being associated with a wireless sensing function supported by the terminal device and the network device; and
transmit the indication information via the transceiver to the terminal device.

12. The network device of claim 11, wherein the indication information comprises a list of access control parameter sets, the list comprising a first access control parameter set for the wireless sensing function.

13. The network device of claim 11, wherein the indication information comprises at least one of the following:
a cell bar indication,
a dedicated cell bar indication for the wireless sensing function,
a cell selection indication indicating whether selection or reselection to intra-frequency cells is allowed, or
a dedicated cell selection indication for the wireless sensing function which indicates whether the selection or reselection to intra-frequency cells is allowed.

14. The network device of claim 11, wherein the processor is further configured to:
receive an indication of the wireless sensing function via the transceiver to from the terminal device.

15. The network device of claim 14, wherein the processor is configured to receive the indication of the wireless sensing function by:
receiving an uplink message associated with a random access procedure, the uplink message comprising the indication.

16. A method performed by a terminal device, the method comprising:
receiving indication information from a network device; and
determining a status of access control of the terminal device based on the indication information, the access control being associated with a wireless sensing function supported by the terminal device.

17. The method of claim 16, wherein the terminal device is communicatively coupled to at least one module, entity or layer which is associated with the wireless sensing function.

18. The method of claim 16, wherein the indication information comprises a list of access control parameter sets, the list comprising a first access control parameter set for the wireless sensing function.

19. A method performed by a network device, the method comprising:
determining indication information for determination of a status of access control of a terminal device, the access control being associated with a wireless sensing function supported by the terminal device and the network device; and
transmitting the indication information via the transceiver to the terminal device.

20. The method of claim 19, wherein the indication information comprises a list of access control parameter sets, the list comprising a first access control parameter set for the wireless sensing function.
